(19) United States
(12) Patent Application Publication
(10) Pub. No.: US 2012/0203706 A1
(43) Pub. Date: Aug. 9, 2012

(54) LISTINGS CHECK-IN SERVICE

(75) Inventors: Carlos Ramiro Teran, San Francisco, CA (US); Douglas Graves, Sunnyvale, CA (US); Jack Mullis, San Francisco, CA (US); John Russell, Palo Alto, CA (US); Kris Wainscott, Sausalito, CA (US)

(73) Assignee: CBS Interactive, Inc., San Francisco, CA (US)

(21) Appl. No.: 13/021,130

(22) Filed: Feb. 4, 2011

(51) Int. Cl. G06Q 99/00

(52) U.S. Cl. 705/319

(57) ABSTRACT

Disclosed are systems, methods, and non-transitory computer-readable storage media for checking consumers in to currently broadcast television content choices to derive consumer profile data. The consumer profile data is analyzed to make programming choices, and to provide enriched programming content. At the same time, the consumer benefits from a social network based on viewers of the same broadcast content, as well as designated friends, wherein the consumers within the network can share commentary on the content choices they are viewing and learn of new content choices.

### BACKGROUND

1. Technical Field

The present disclosure relates to consumer check-ins to media and more specifically to using consumer check-ins to create online social groups sharing the same content choice experience.

2. Introduction

E-everything. We are in the midst of an enormous push to capitalize on consumer's increasing tendency to want to do everything online. Consumers now partake in e-commerce, experience electronically-distributed content, and even engage their friends electronically. In general, consumers are finding new ways to move many real-world activities to electronic media.

Such a movement has led to many highly developed systems and websites to facilitate consumer's continued progress toward more electronic-based lifestyles. Just some of the well known examples include electronic commerce retailer AMAZON.COM® online retail services, social networking websites FACEBOOK® online social network, and LINKED-IN® online business networking services, and electronically-distributed content providers, ITUNES®, HULU®, NETFLIX®, to name a few examples.

Due in part to the success of these electronic-lifestyle-facilitating services many others are making their own attempts at bringing additional aspects of daily life to consumers in electronic means. Two such examples include services that allow consumers to create social networks with a common interest in television at their center, PHILO and MISO. Both services allow consumers to check in to a television content choice and share this information with their network of friends. Both services allow consumers to search for an episode of a television program and check in. Such services may help consumers to learn of new content by showing a consumer which content choices are the most popular according to number of check-ins. However, such services are only social in that they utilize a consumer's network of friends, and in some cases the population as a whole, to introduce a consumer to new content choices. These services fall short at recreating the traditional social aspects of television watching.

Accordingly, technologies that utilize online collaborative and informative resources for creating a richer and more social environment related to experiencing content choices are needed.

### SUMMARY

Additional features and advantages of the technology, including systems, methods, devices, and computer-readable media having instructions for causing a computing device to carry out methods, will be set forth in the description which follows, and in part will be understood to persons skilled in the art from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are technologies for instructing a computing device to perform methods, for checking consumers in to multi-media content (herein after referred to as “content”), at least in part to derive consumer profile data. The consumer profile data can be analyzed to adjust content programming to include programming that is more likely to be of interest to the consumer or population of consumers, and to provide content that is complementary to the programming to provide an enriched viewing experience. At the same time, the consumer benefits from a social network based on viewers of the same content, as well as designated friends, wherein the consumers within the network can share commentary on the content they are viewing, have viewed, and/or plan to view, and learn of new content using on-line functionality to attract viewers to the content.

In some embodiments, a listings check-in service can provide a consumer interface displaying listings information. The listings information can include content choices that are available for check-in at a specified time. The listings information is not limited to scheduled programs, as in the traditional sense of broadcast or cable television listings. Rather listings information can include unscheduled content that has been watched, is currently being watched, or is planned to be watched, e.g., on demand content, or an unscheduled viewing, such as from a digital video recorder, digital video disk (e.g., DVD, Blu-Ray), or online streaming service such as Netflix or YouTube®. The term broadcast, as used herein, should not be considered limited to any traditional meaning such as broadcast over spectrum or cable. Rather broadcast is used to broadly indicate that content is available for check. For example, content can be available for check-in if two or more consumers can be joined in a live chatter feed to discuss the designated content. Most often such chatter feeds are available when the content is actually available for viewing, but can also be available at scheduled times to facilitate community discussion of a specified content. In short, the present technology provides listing information of content available for check-in by consumers.

Consumers can be presented with the listings information and can elect to check in to a content choice represented in the listings interface using their consumer device, such as an iPad, a smart phone, an Internet-enabled television. Such check-in action is recorded by the listings check-in service, wherein the consumer is designated as checked in to the identified content.

The listings check-in service can notify other consumers checked in to the same content, and can notify the consumer's friends (as designated in the consumer's profile) of a consumer's status as checked in to the content. Further, other groups of people can be notified, such as followers and members of other on-line social networks. Additionally, consumers that are checked in to the same content can be joined in a shared communication channel to create a group chat. The group chat, or chatter as it is sometimes called, can be at least temporarily stored.

Both the check-in data and the chat data can be analyzed to identify audience demographic information related to the content choices, live audience data, trending topics, and other conclusions based on one or more analytics. This processed data can be used to make advertising and programming decisions.

In some embodiments the content choice listings can be dynamically updated in response to consumer actions. For example a consumer can identify a content choice and schedule a later viewing. The later viewing can be added to the content choice listing so that other consumers can share in the viewing experience.

### BRIEF DESCRIPTION OF THE DRAWINGS

In order to describe manners in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment;

FIG. 2a illustrates an exemplary listings interface;

FIG. 2b illustrates an exemplary listings interface;

FIG. 3 illustrates an exemplary collection of badges that can be awarded to consumers;

FIG. 4 illustrates an exemplary interface for, inter alia, changing the channel on a consumer's television;

FIG. 5 illustrates an exemplary user interface screen that presents a stream of comments from other consumers that are also checked in to the same content;

FIG. 6 illustrates an exemplary interface that identifies other consumers checked in to the indicated content;

FIG. 7 illustrates an exemplary activity feed;

FIG. 8 illustrates an exemplary interface that is configured to filter listings by favorites or friends;

FIG. 9 illustrates an exemplary interface that is configured to display the consumer's friends' favorite contents;

FIG. 10 illustrates an exemplary report based on check-in data;

FIG. 11 illustrates an exemplary screen of supplemental content;

FIG. 12 illustrates exemplary methods; and

FIG. 13 illustrates exemplary systems.

### DETAILED DESCRIPTION

Various embodiments of the technology are discussed in detail below. While specific implementations are discussed, it should be understood that this is done for illustration purposes only. A person skilled in the relevant art will recognize that other components and configurations may be used without parting from the spirit and scope of the technology described in this disclosure.

The present technology addresses the need in the art to utilize online collaborative and informative resources for creating a richer audio-visual experience. Consumers have shown that they are willing to leave behind a rich trail of data if the online experience is fulfilling enough. That rich trail of data is valuable in learning about a specific consumer and an audience in general. The data collected can be processed to make programming choices, target advertising, and provide additional features to the consumer.

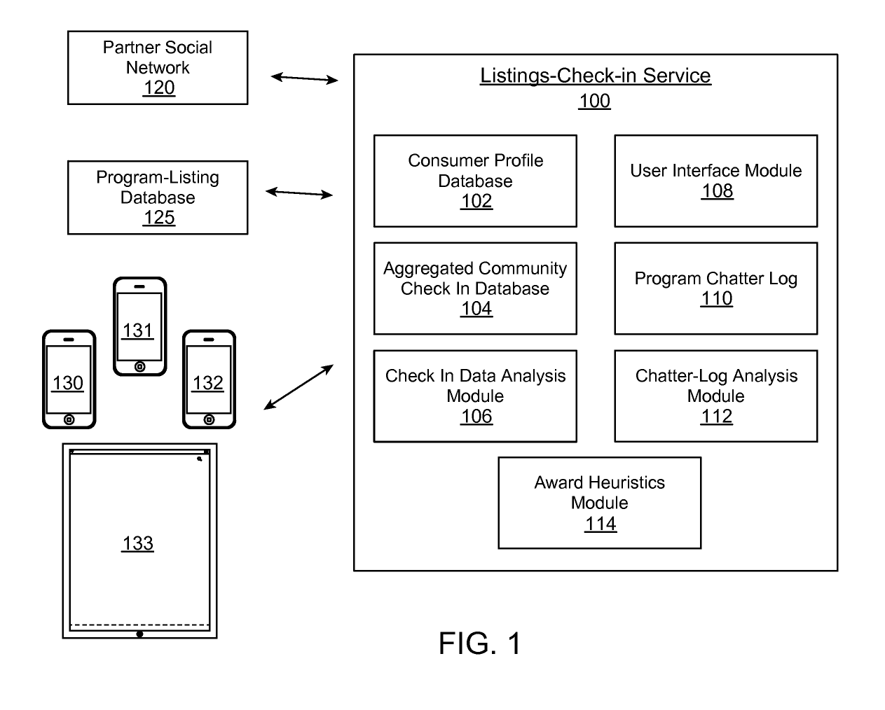

FIG. 1 illustrates an exemplary system embodiment. As illustrated, a listings check-in service 100 is in electronic communication with a social network 120, a content-listing database 125, and consumer devices 130-133. The system operates to provide the consumer devices 130-133 with listings information in a graphical user interface configured to accept consumer inputs to allow a consumer to check in to content choices. The listings check-in service 100 records the check-in data and provides a service based on a consumer's status as checked in to a content choice.

A check-in, as will be used throughout this specification, is typically a consumer indication that the consumer is currently watching a content choice, but in some instances can be a consumer action for accessing a chatter feed related to the content choice. In some embodiments a consumer only can be checked in to one content choice at a time. As described herein, in some embodiments a consumer can check in passively to a content choice, for example, by changing a channel to the content in broadcast television, and in some embodiments, a consumer must affirmatively check in to a content choice. Additionally, in some embodiments a consumer can check in to a content choice based on a prior indication that the consumer plans to experience a content choice at a specified time. At that specified time, the listings check-in service 100 can automatically check the consumer in to the content choice. In some embodiments, this automatic check-in can be coupled with an alarm to remind the consumer that she is about to check in to the content choice.

As illustrated, the listings check-in service 100 maintains a consumer-profile database 102. An entry for each consumer using the service is created in the consumer-profile database 102 upon the initial login. In some embodiments, a consumer will create login credentials and provide the necessary data to create a consumer profile. In some embodiments, the listings check-in service 100 retrieves the data from a social network 120. In such embodiments, the consumer can login to the listings check-in service 100 using credentials from the social network 120. Upon login using credentials associated with a social network 120, the social network 120 can verify the credentials and then share the required consumer profile data and save the consumer from having to enter the data themselves.

The social network can be any social network such as FACEBOOK, MYSPACE, LINKEDIN, among others. Additionally new social networks spring up frequently. Any and all social networks could potentially be the social network 120. While the social network 120 is illustrated as separate from the listings check-in service 100, it should be appreciated that the social network could be a part of the listings check-in service 100, or separate but managed by, owned by, or related to the same entity as the listings check-in service 100.

Referring back to the consumer-profile database 102, at initial log in, the consumer profile can contain at least basic demographic data, including age, gender, and general geographic information, among other potential demographic attributes. However, as the consumer uses the listings check-in service 100, the data stored in the consumer's profile can grow. For example, it can store information pertaining to awards won from the listings check-in service 100, favorite content choices, most recently watched content choices, friend associations, etc. It should be appreciated the collection of this profile information should be recorded consistent with a lawful privacy policy of which the consumers have accepted the terms.

The listings check-in service 100 also includes a user interface module 108. The user interface module 108 contains information that can be sent to the consumer devices 130-133 that will be used to populate a user interface rendered on the consumer devices 130-133. One type of information that is sent from the user interface module 108 is content listings information. The content listings information can be downloaded from a content listings database 125. In some embodiments, the content listings database is maintained by a commercial service that provides such information, while in some other embodiments the content listings database could be maintained as part of the listings check-in service 100.

A consumer can access the listings check-in service 100 using a consumer device. For example, consumer device 130-133 can be a smartphone, personal-media-playing device, tablet computer, communication network connected television, laptop or desktop computer or any other computing device that is in communication with the listings check-in service 100. The consumer can access the listings check-in service 100 by entering a URL to access a web-based application, or can download and run a locally stored application specific to the listings check-in service 100, e.g., an application native to the consumer device.

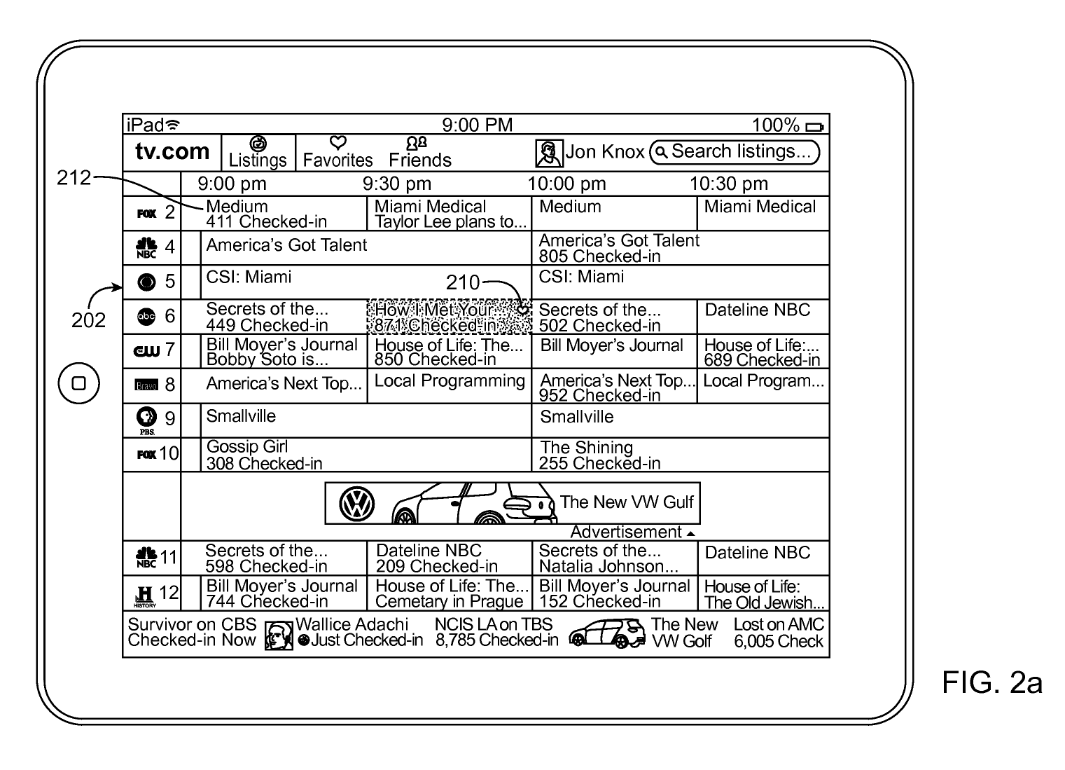

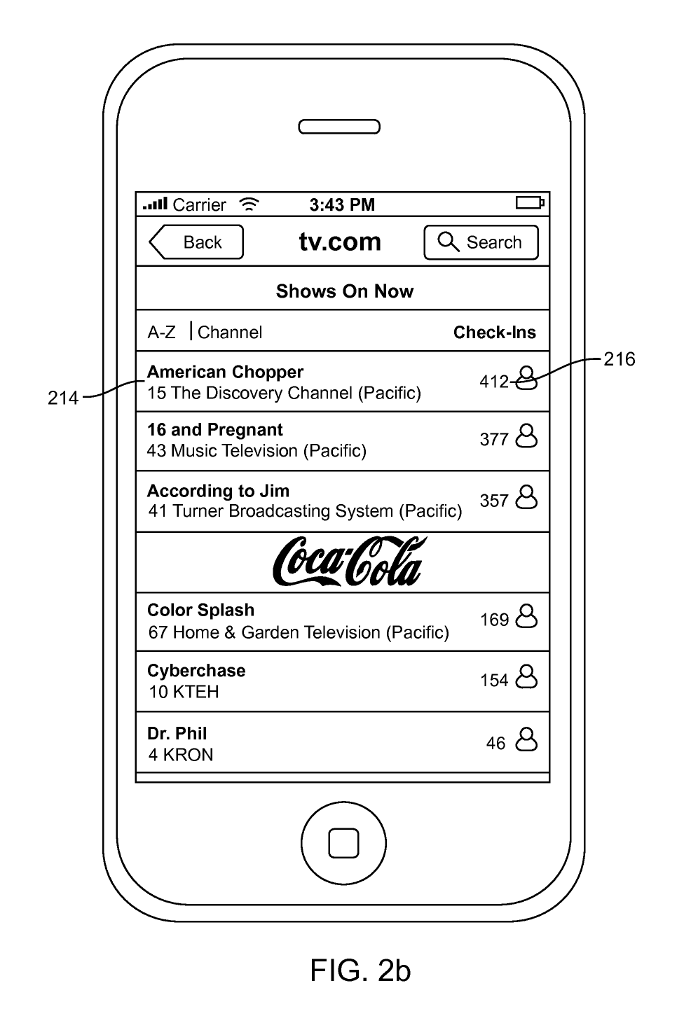

FIG. 2a and FIG. 2b illustrates two different exemplary listing interfaces 202, 204, respectively, presented on consumer devices, which provide at least local television listings 212, 214. In some aspects, the listings are the same listing information that a consumer would see presented by his/her cable provider or at least the same listings as available in the consumer's local zip code. The consumer's local zip code or cable provider can be known from demographic information contained within the consumer-profile database 102. In some aspects the listings contain any content choices that are currently playing or scheduled to play at a specified time and are potentially available to the consumer.

FIG. 2A also illustrates a graphical indication of a favorite content choice 210 included in the listings interface. FIG. 2B illustrates a number of consumers checked in to a given content 216.

The listings information can also include content choices beyond those which are provided by a local cable provider. In some embodiments, the listings information includes content that is currently being watched by a consumer that were not scheduled for broadcast such as an on-demand content, streaming content, or even locally sourced content such as from one consumer's local digital video recorder or optical video disk player (e.g., DVD or Blu-Ray player, etc.). In some embodiments, the listings information can also include listings related to content choices that while not currently being watched by any consumer, are available for discussion in a chatter feed. In some embodiments the listings information can also include content choices that a consumer plans to watch at a specified time, e.g., a scheduled viewing.

The listing screen 202, 204, illustrated in FIG. 2, can be active to receive consumer inputs. The user interface controller on the consumer device receives consumer inputs indicative of the consumer's intention to check-in to a selected content choice that is listed in the television-listing interface 202, 204. When a consumer checks-in to a content choice, the listings check-in application transmits data representative of the consumer's designation as being checked in to the listings check-in service 100 where it is stored in the aggregated community check in database 104 and optionally can also be stored in association with the consumer's profile in the consumer-profile database 102. Further, the information can be used by the user interface module 108, as addressed below, to indicate who is checked in to a content choice. In some embodiments, the consumer's designation as being checked in can also be transmitted to the social network 120 for posting on the network 120, subject to the consumer's preferences.

The check-in feature takes advantage of a consumer's willingness to interact with friends through social media systems, and to publicize the events of the consumer's life to the consumer's network. However, some consumers are less likely to want to check in or to share the daily events of their life, and accordingly the system can also incentivize the consumer to check-in to content. In some embodiments of incentivizing consumers, consumers can be given awards for checking in to content or for other conduct that is deemed worthy of encouragement or discouragement.

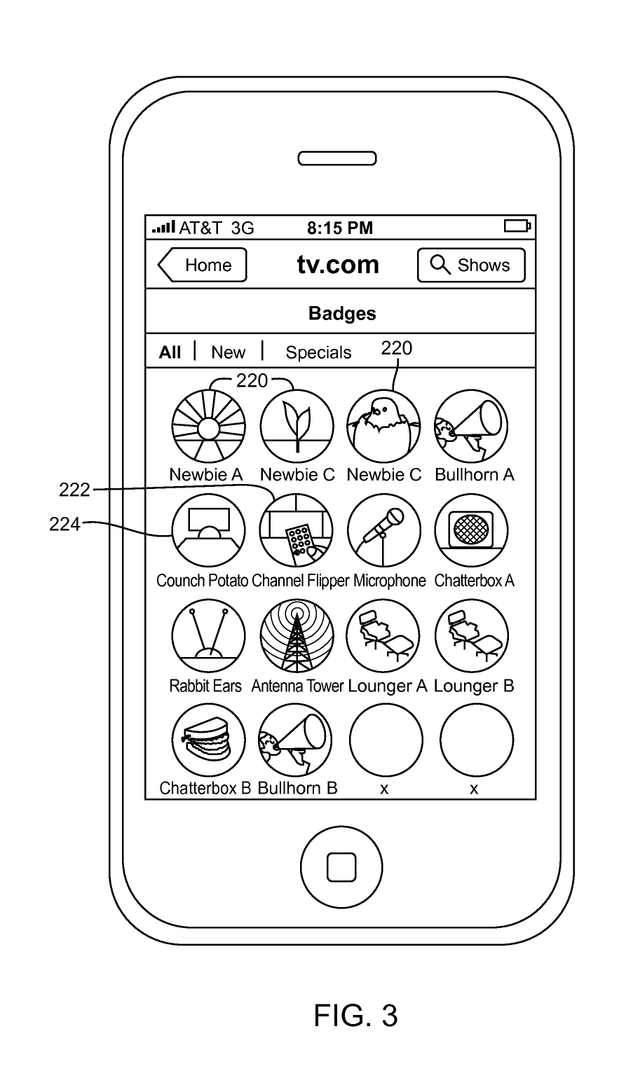

FIG. 3 illustrates an exemplary collection of badges that can be awarded to consumers. The awarding of badges can be based on the evaluation of consumer's actions, either as they occur, or recorded in a log. For example the award heuristics module 114 can analyze the consumer's actions as stored in either the consumer-profile database 102 or the aggregated community check in database 104, and determine if the consumer is eligible for an award.

As illustrated in FIG. 3, several badges are labeled newbie 220. Such badges can be awarded based on an initial log-in to the system or after a first check in.

The channel flipper badge 222 can be awarded in response to an analysis of a database 102 or 104 showing that a consumer has checked in to N, e.g. 3, or more content choices during a period, e.g., 30-minute period on at least X, e.g., 5, separate occasions. It should be appreciated that the exact criteria can be adjusted, but the channel flipper badge would generally be awarded to consumers who demonstrate a tendency to check in to several shows during a relatively small time period, for example a listings time slot. When analysis of the database associated with a consumer meets this criteria, it can be heuristically determined that she should be labeled a channel flipper.

Likewise, the couch potato badge 224 can be awarded to consumer's whose profile demonstrates that they have a tendency to spend more than a determined period watching television, as determined by repeated check-ins to television content.

Each of the badges serves to reward the consumer for interaction with the system. Another mechanism by which to award consumers is to provide them with quotes or trivia from the respective consumer's favorite content choices.

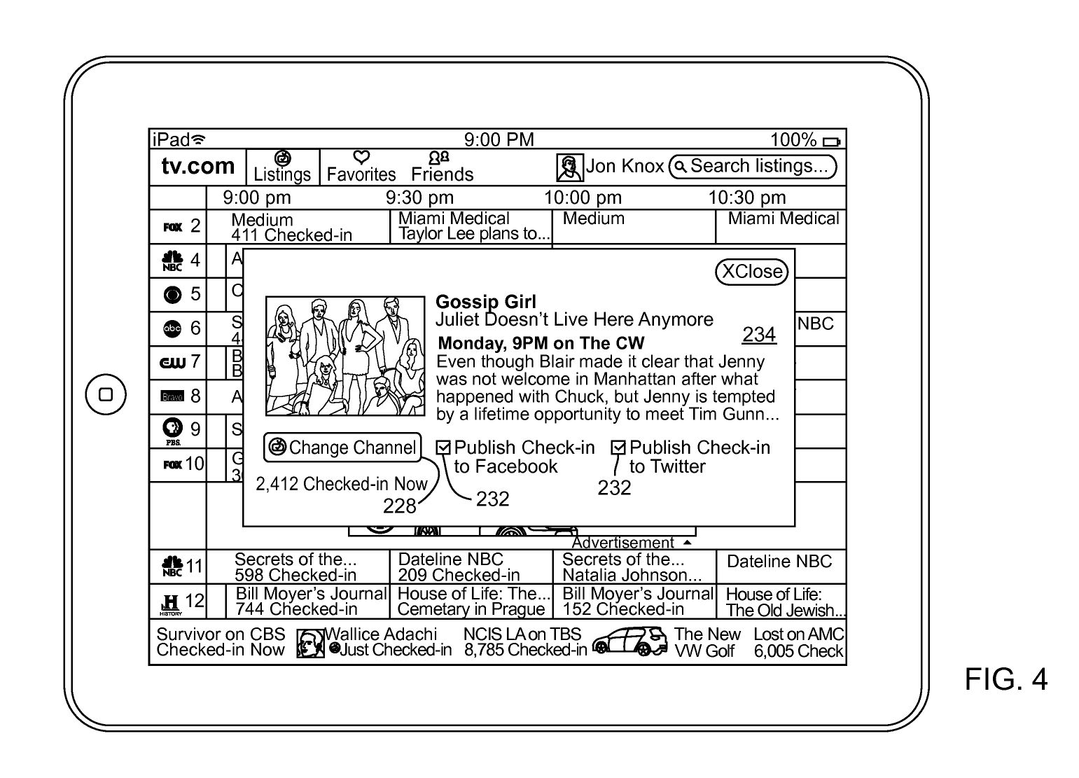

Another mechanism to drive consumers to interact with the system and to check-in to broadcast content is to couple the listings feature with a remote control. FIG. 4 illustrates an interface for, inter alia, selecting content on a consumer's television 234 (or other content viewing device). In this embodiment, a consumer has selected a content choice and the user interface has presented the consumer with more detailed information about the choice and provides the consumer with an option to change to the selected content 228, in this example change the channel.

In order to change the content presented on the viewing device, the technology of the present disclosure can communicate with the consumer's viewing device, e.g., a television receiver, which may in some case include a separate set top box. In some embodiments of the content change feature, the system can wirelessly communicate with a television receiver through a Wi-Fi network. In other embodiments a computer or portable device can be outfitted with an infrared transmitter (either integrated or as an accessory). Many other potential communication mechanisms are well known and they could also be used to provide at least one-way communication between the consumer's device and the television receiver.

In some embodiments, when a consumer selects the change content option, the consumer is also checked-in to the selected content. As the consumer switches from one content choice to another on a viewing device, the consumer can be checked-out of a previous content choice and checked in to the subsequent content choice. The listings check-in service 100 can abide by a consumer preference designating whether the consumer should be checked-in to content choices automatically as a result of changing the content on the viewing device.

In addition to publishing a consumer's check in to the listings check-in service, a consumer's check-in status also can be published to the social network 232.

As mentioned above, the act of checking in to content can drive other features and benefits. One such benefit is transforming the viewing experience from an individual viewing experience into a widely attended event where each “attendee” shares at least one thing in common—they are all watching the same content choice at the same time. And just like any other event, consumers can socialize with others also in attendance, or browse the attendees.

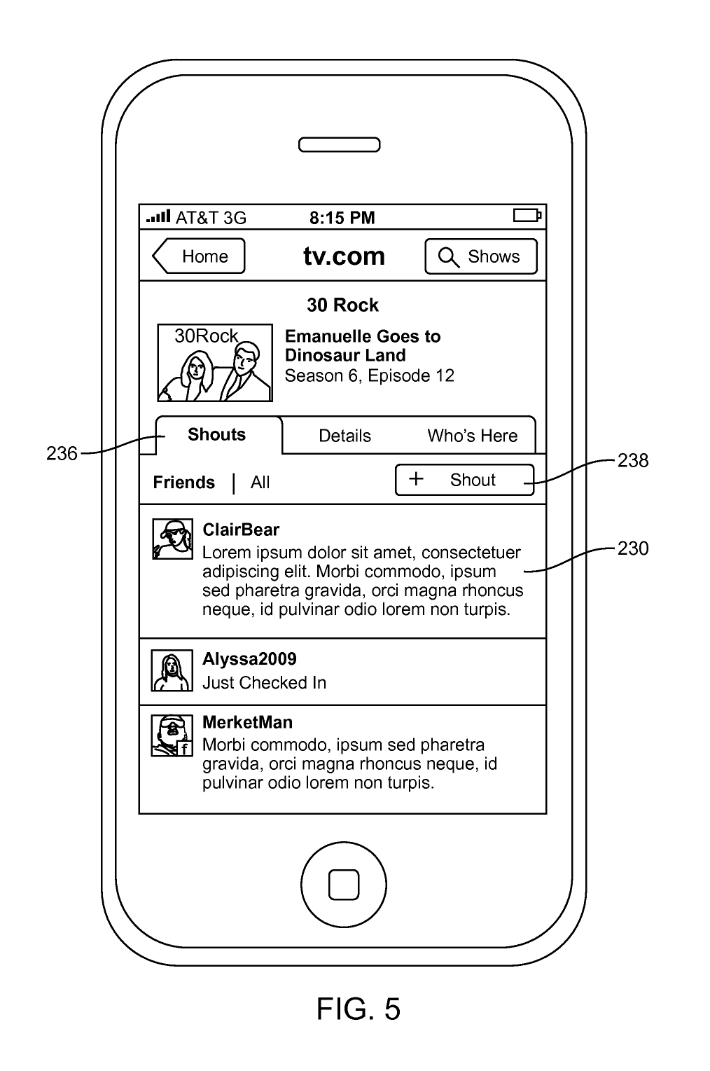

FIG. 5 illustrates a user interface screen that presents a stream of comments 230 from other consumers who are also checked in to that content choice at the same time. Through this interface, a consumer is able to experience television watching in a more social environment. However for some consumers, experiencing every other consumer's comments might result in too much “noise” and detract from the experience. Accordingly, consumers also have the option to filter the stream, e.g., to view only comments from a subset of consumers, e.g., consumers that are designated friends 236. Consumers can also provide their own comments by selecting the user interface button 238.

In some embodiments the stream of comments can be stored, at least temporarily, in a chatter log 110 for analysis by the chatter-log analysis module 112, addressed below.

Friends can be identified by requesting “friend” relationships, by identifying friends by supplying email addresses, or by importing friends from social networks 120.

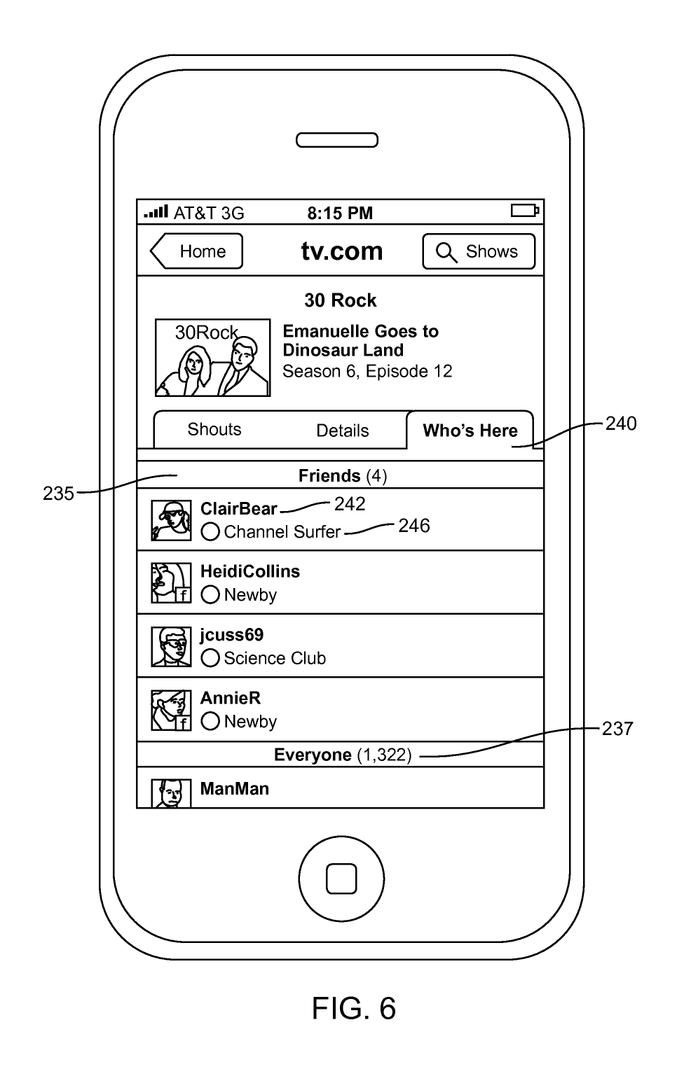

FIG. 6 illustrates a similar interface wherein consumers can see who else is checked in to the content choice at the same time by selecting tab 240. This interface can also distinguish between various subsets, e.g., friends 235 from the masses 237.

A first consumer can also see a second consumer's activity. In some embodiments the second consumer is a friend, or any other second consumer who has published their activity to a subset of consumers that includes the 1^{st} consumer. As illustrated in FIG. 6, other consumers can be identified along with their screen name 242 and any awards or badges 246 that have been awarded to them.

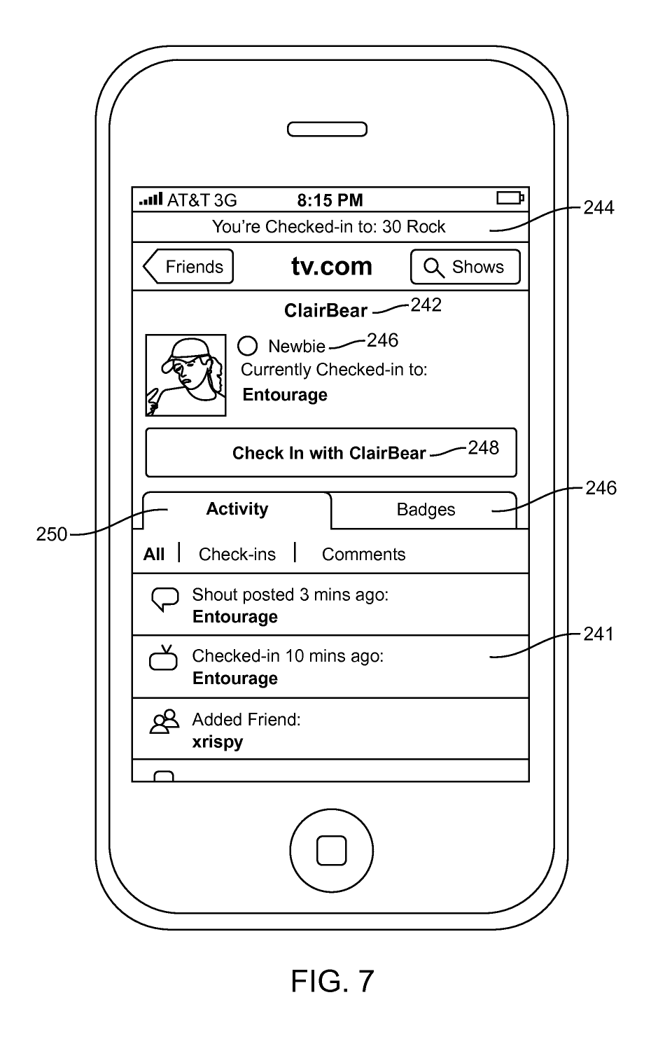

FIG. 7 illustrates a friend's activity feed. At the top of the screen, the consumer's present status is indicated 244, while the rest of the page displays information regarding the friend's activity. One example that can be displayed in the activity feed 250 includes content choices that the friend has recently checked in to 241, comments posted 230, badges awarded 246, etc. If the consumer wants to experience the same content choice that his friend is currently checked in to, he can check in to the same show from the friends activity feed by selecting the user interface button 248 and experience the content choice with his friend through the presently described technology.

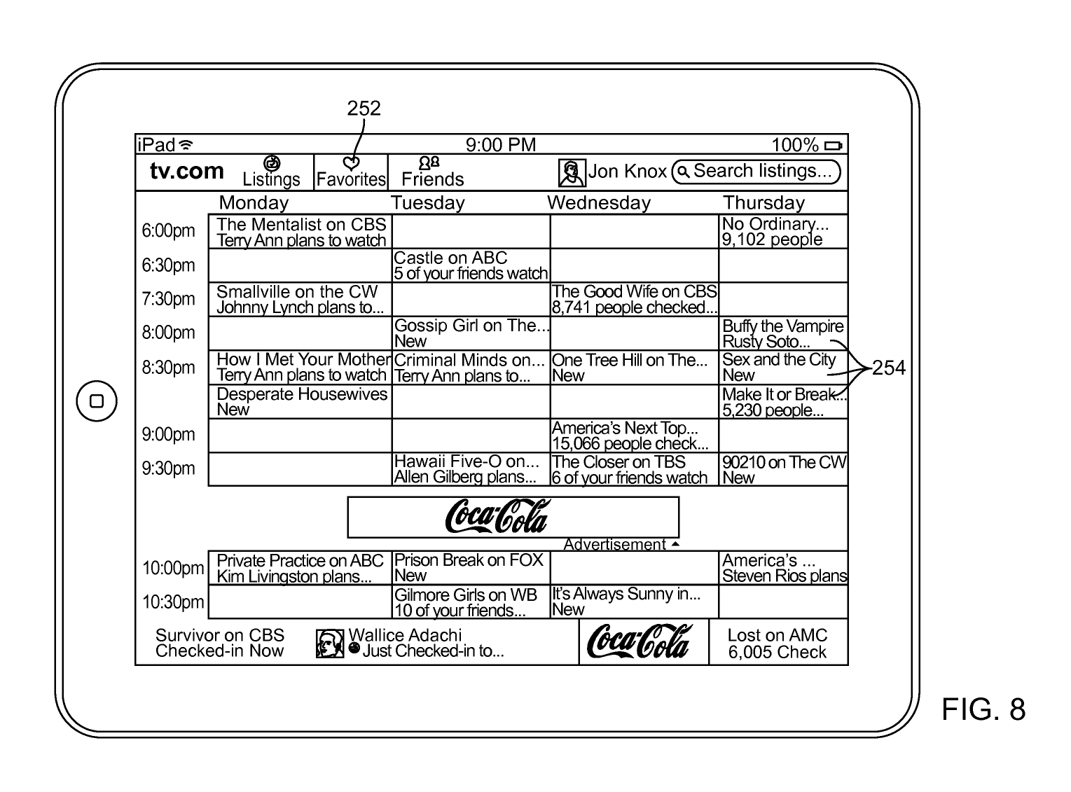

Another benefit that is driven by the check-in feature is a mechanism by which a consumer's collection of friends can passively lead the consumer to learn about content they may enjoy. FIG. 8 illustrates an interface that is configured to filter television listings by at least favorites or friends. In FIG. 8 the interface displays the consumer's favorite 252 content. As can be seen, content on a consumer's favorites list are displayed 254 so that the consumer can easily see when her favorite content is scheduled to be presented for playing. In the exemplary illustration, only listings that are considered favorites are displayed. All other listings are left blank. In other embodiments, all listing for the displayed period are displayed, and favorites are marked as such.

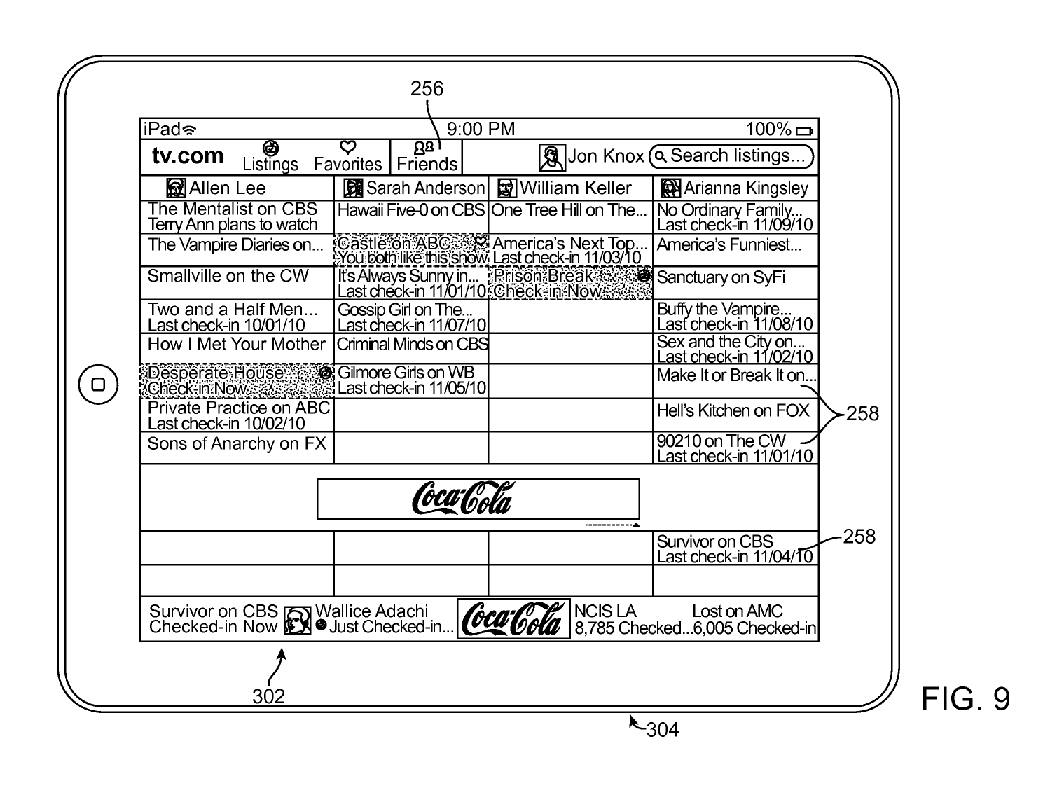

As illustrated in FIG. 9, a similar interface can also be used to display when other users, e.g., the consumer's friends', favorite content choices 256 are scheduled to be presented for viewing. In some embodiments, all friends' favorite content listings can be displayed 258. In other embodiments only selected friends' favorite content listings are displayed. In some embodiments, all listings for the displayed period are, and friends' favorites are marked as such, in some embodiments with an indication of the friend for which the content is a favorite. In some embodiments, content listings that are the collective favorite of the consumer's group of friends are displayed. In this way, a consumer can be introduced to the content that other users (e.g., his friends, preferred critics) are watching and join them by checking-in to the same content listing.

Also illustrated in FIG. 9 is a data stream of alerts. For example 302 is an example of an alert that a friend just checked in to a specified content listing. 304 is an example of an alert that a favorite content choice is currently being broadcast.

In some embodiments, the content can be any content that can be distributed to two or more consumers over any medium. The present technology provides for creating a social forum for enjoying or discussing content. In one example, the content can be television programming, wherein consumers can check in to content while it is being presented.

In another example, the content can be a movie watched on demand. A consumer could designate a time for watching the movie, which can be displayed in the content listing. Other consumers could then also watch the same movie on demand and check in to the movie. By checking in, the consumers can take advantage of the features discussed above, such as the comments feed.

In another example, a consumer could send a calendar invitation to one or more friends to schedule a viewing time for a favorite content choice.

In some embodiments, a consumer can schedule a viewing of a favorite content choice and be joined by other consumers who also consume that content choice. In some aspects, the content choice does not need to be from a source that is sharable. For example, each consumer could watch the content choice from their own personal copies at the designated viewing time. Despite consuming separate copies of a content choice, each consumer can still engage each other through the chatter feed and other social features described herein. That the content is a personal copy does not eliminate other features of the present technology such as additional information about the content choice on a second screen. When a content choice is scheduled, the system can learn of the content choice and provide any feature discussed herein. In some aspects, if enough consumers indicate they plan to participate in the scheduled viewing, the system could enact a programming change and make the content available more broadly.

In some embodiments, the present technology can also facilitate pre-viewing and post-viewing chats to mimic “water cooler talk.” In such embodiments, users could check into a previously aired content choice and discuss. The post-viewing chat could optionally be at scheduled times.

Collectively, these features can create an engaging consumer experience that can turn any broadcast content into a live event, and function to introduce consumers to new content based on what other users, their friends, or the population at large is watching. “Live event” can refer to a shared, though not necessarily co-located, viewing experience with access to features and information provided through check-in. However, creating this consumer experience is not only beneficial for a consumer, but also for the content providers because while consumer's check-in, activity while checked in, and check-out of content choices, the system can log and analyze data about the population's viewing and interaction patterns.

The check in data analysis module 106 is configured to perform several different analytics of the collected check in data to determine consumer consumption statistics. For example, the check in data analysis module 106 can analyze check in data to determine viewing preferences by different demographics. This information can be valuable in attracting advertising.

Additionally, the check-in data analysis module 106 can identify segments out of the population based on average amount of time spent checked in to content, which, in some embodiments can be inferred from the amount of time the consumers in population spent watching the content. This can become a behavioral demographic and can be used to determine what consumers—who experience relatively little content—consume.

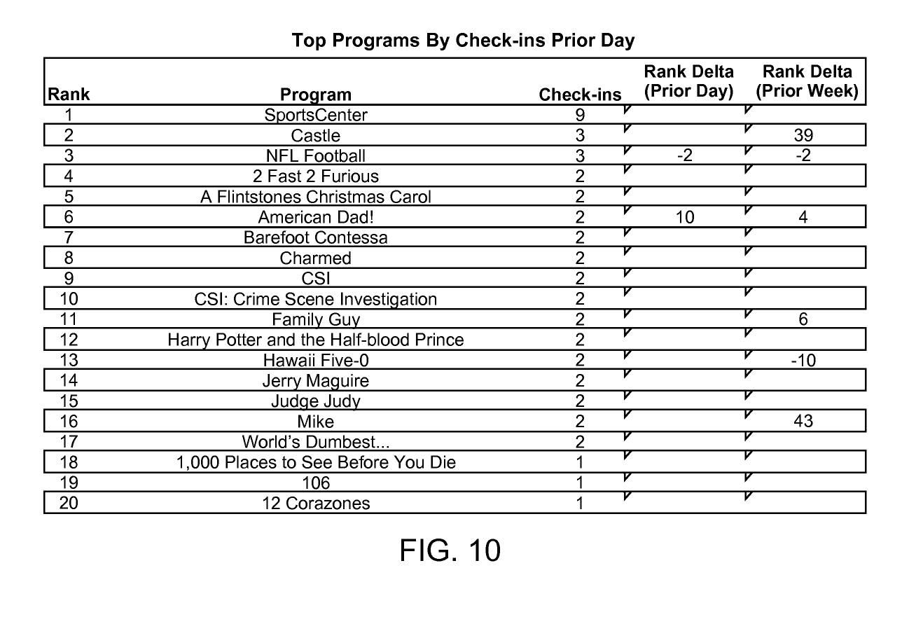

Since the listings check-in service 100 can be based primarily on listings of content, the check in data analysis module 106 is able to identify what types of content choices are most popular. A simple example report showing a number of check-ins per content choice is illustrated at FIG. 10. This information can be compared to data recorded by, for example, digital video recorders and on-demand service providers to determine which content choices are more likely to be viewed when aired rather than recorded and watched at the consumer's convenience. This type of data can be extremely powerful for making programming choices.

One type of programming decision is to air more of the content that consumers watch live during peak hours. Another type of programming decision is to provide more content to enhance those content choices that are watched live. In some embodiments, metadata regarding the content can be displayed during the content presentation to further enhance the viewing experience. In some embodiments, rather than present content with metadata, the metadata can be provided through the listings check-in service 100. In such embodiments, a consumer could watch the content on their normal viewing screen, e.g., a television, and enjoy additional content if they choose on their consumer device displaying the user interface provided by the listings check-in service 100 and the user interface module 108.

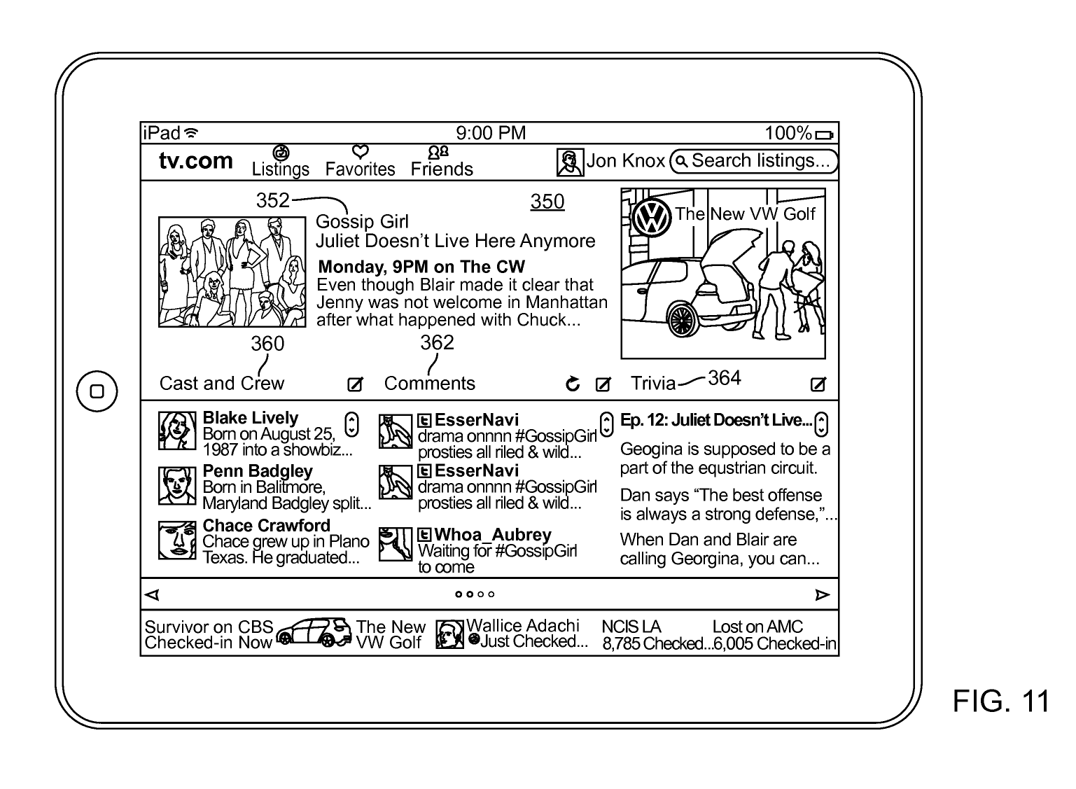

FIG. 11 illustrates an exemplary screen 350 of information, e.g. supplemental content, about the content choice to which the consumer is presently checked in. This interface shows information about the episode 352 details about the actors 360, a live stream of chatter 362 from the community also watching the content choice, and trivia 364. However, it should be appreciated that a wide variety of information could be displayed on this screen. In some embodiments, the content selection can be based on the results of an analysis of the consumer commentary stream.

Multiple screen viewing also opens up the possibility of customized viewing experiences wherein the consumer can interact with the features that interests them. In some embodiments, a record of features the consumer interacts with can be made and used to determine which features are most important to a specific consumer or consumer type, and in turn more of that type of feature or less of other features can be provided.

It should also be appreciated that each of the features discussed above could also be presented on the primary viewing screen as well. In such embodiments, the listing-check-in application could be executed on a cable box, digital video recorder, television, etc. to provide complementary content on the main viewing screen.

As addressed above, consumers can also engage in a live conversation with a friend or with the entire viewing population. These conversations can be at least temporarily stored in the chatter log 110 and analyzed by the chatter-log analysis module 112. The analysis module 112 can determine which content choices are the most discussed or identify a particular trending topic or conversation trend. Such analysis can also be used to adjust programming choices, or can be used to adjust any content that is being presented on a second screen through the listings check-in service 100 to meet or enhance consumer interest.

In some embodiments programming choices can be adjusted on the fly based on data analysis by the system. For example the system could determine that a particular content choice is being discussed with a high frequency and then make that content choice or related content choice available for viewing by listing the content in the content listing and providing it on demand, or at specified times.

In some embodiments, the present technology can also be used to create content experience groups. For example, a collection of consumers can form a group that experiences the same content together routinely. In some embodiments, other consumers could potentially relate to a content experience group and either join, or take recommendations of new content to experience from the group.

In some embodiments, the present technology can also be used to create personalized programming wherein the system can learn of a consumer's favorite content choices and the consumer's friend's favorite content choices and create a broadcast of content from those content choices. In some embodiments the content choices could be provided in the consumer's profile and be made available on demand. In some embodiments, the technology could create a channel, and make programming selections for the consumer and list the selections and the airing times in the listings interface.

In some embodiments the data analysis addressed above can be performed by the listings check-in service, and in some embodiments the data analysis can be performed by a separate server which receives and aggregates data collected by the listings check-in service.

Other related features can also be offered by the listings check-in service 100. While the listings check-in service 100 is primarily configured for dealing with broadcast content, the service can also record whether a consumer has already seen a particular episode. Accordingly when that same episode is shown again in the broadcast listings, the service can provide a visual indication reminding the consumer that they have already viewed the episode.

An additional embodiment is to allow consumers to check in from outside the listings check-in service 100. If the consumer desires, she could check in from other websites that partner with the listings check-in service.

In some embodiments, the content can be distributed from a Multichannel Video Programming Distributor (MVPD), a conventional over-the-air broadcaster, an online store, a video streaming source such as Netflix or YouTube, a digital video recorder, or any other device or entity for distributing content. Any consumer having access to the content can check in to the content and experience the content in a social context with other consumers that are also checked in to the content. In some aspects the users could both be watching a movie on the same screen, while in other aspects the users could be in different parts of the world experiencing the same music broadcast.

While the embodiments above have been described with respect to joining consumers in a chat session, it should be appreciated that other modalities of communication are equally applicable, such as, voice, and video, etc.

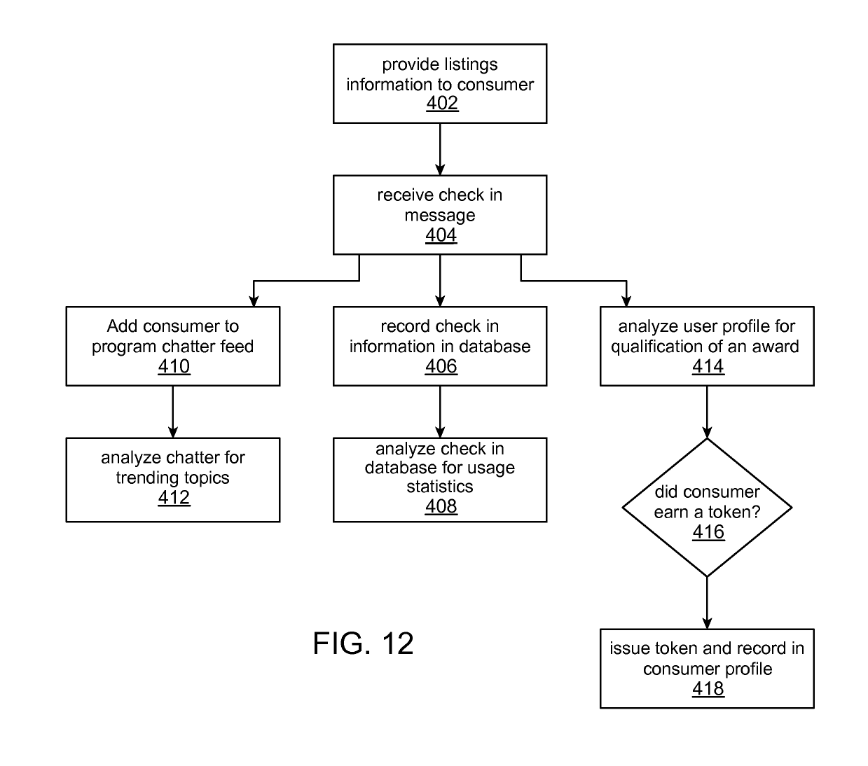

Having disclosed some basic system components and concepts, the disclosure now turns to the exemplary method embodiment shown in FIG. 12.

The listings check-in service 100 can provide 402 listings data to consumers to be viewed on their consumer devices 130-133. When a consumer checks in to a content choice, the consumer device 130-133 can send a check in message, which is received 404 by the listings check-in service 100. The listings check-in service 100 can record 406 the check in information in a database 102 and/or 104, and analyze 408 the check in database(s) for usage statistics.

The act of checking in, by a consumer, can trigger other events. For example the consumer can be added to a chatter feed 410, which includes other consumers watching the same content choice at the same time. The chatter or commentary posted to the chat feed can be recorded in a log 110, and analyzed 412 for trending topics by an analysis module 112.

The act of checking-in can also cause the consumer profile to be analyzed for various data points. As illustrated in FIG. 12, after a consumer completes the act of checking in to a content choice, the consumers profile can be analyzed for qualification for an award 414, and if the award heuristic module 114 determines 416 that the consumer did earn an award, the consumer can be issued a token and the award can be recorded in the consumer's profile 418.

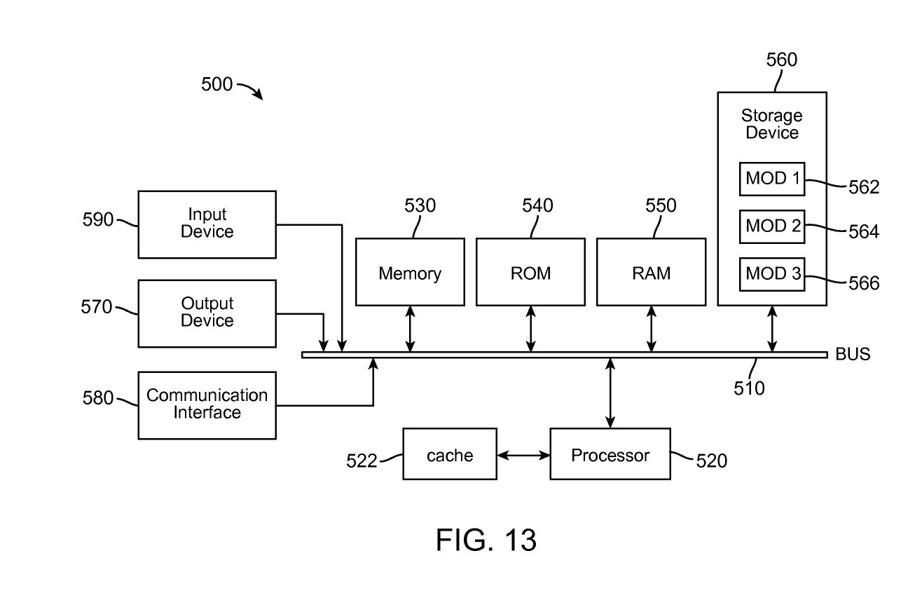

For the sake of clarity, the method is discussed in terms of an exemplary system 500 as shown in FIG. 13 configured to practice the method. For example, the system 500 can be configured to operate one or more steps performed by the listings check-in service 100. In some embodiments, the system 500 can also describe the underlying system of the consumer devices 130-133. The steps outlined herein are exemplary and can be implemented in any combination thereof, including combinations that exclude, add, or modify certain steps.

With reference to FIG. 13, an exemplary system 500 includes a general-purpose computing device 500, including a processing unit (CPU or processor) 520 and a system bus 550 that couples various system components including the system memory 530 such as read only memory (ROM) 540 and random access memory (RAM) 550 to the processor 520. The system 500 can include a cache of high speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like; each either local or available over a communications channel. The storage device 560 can include software modules 562, 564, 566 for controlling the processor 520. Other hardware or software modules are contemplated. The storage device 560 is connected to the system bus 510 by a drive interface. The drives and the associated computer readable storage media provide nonvolatile storage of computer readable instructions, data structures, program modules and other data for the computing device 500. In one aspect, a hardware module that performs a particular function includes the software component stored in a non-transitory computer-readable medium in connection with the necessary hardware components, such as the processor 520, bus 510, display 570, and so forth, to carry out the function. The basic components are known to those of skill in the art and appropriate variations are contemplated depending on the type of device, such as whether the device 500 is a small, handheld computing device, a desktop computer, or a computer server.

Although the exemplary embodiment described herein employs the hard disk 560, it should be appreciated by those skilled in the art that other types of computer readable media which can store data that are accessible by a computer, such as magnetic cassettes, flash memory cards, digital versatile disks, cartridges, random access memories (RAMs) 550, read only memory (ROM) 540, a cable or wireless signal containing a bit stream and the like, may also be used in the exemplary operating environment. Non-transitory computer-readable storage media expressly exclude media such as energy, carrier signals, electromagnetic waves, and signals per se.

To enable consumer interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a consumer to provide multiple types of input to communicate with the computing device 500. The communications interface 580 generally governs and manages the consumer input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 520. The functions these blocks represent may be provided through the use of either shared or dedicated hardware, including, but not limited to, hardware capable of executing software and hardware, such as a processor 520, that is purpose-built to operate as an equivalent to software executing on a general purpose processor. For example the functions of one or more processors presented in FIG. 13 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 540 for storing software performing the operations discussed below, and random access memory (RAM) 550 for storing results. Very large scale integration (VLSI) hardware embodiments, as well as custom VLSI circuitry, Application-Specific Integrated Circuits (ASICs) and Field Programmable Gate Arrays (FPGAs) in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 500 shown in FIG. 13 can practice all or part of the recited methods, can be a part of the recited systems, and/or can operate according to instructions in the recited non-transitory computer-readable storage media. Such logical operations can be implemented as modules configured to control the processor 520 to perform particular functions according to the programming of the module. For example, FIG. 1 illustrates three modules Mod1 562, Mod2 564 and Mod3 566 which are modules configured to control the processor 520. These modules may be stored on the storage device 560 and loaded into RAM 550 or memory 530 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules and data may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method comprising:
providing, by a listings check-in service, data descriptive of a listing of content choices available for check-in to a consumer;
receiving a check-in message indicative of the consumer's intention to check in to one of the content choices presented in the listing of content choices; and
recording an indication of the consumer's status as checked in to the content choice.

2. The computer-implemented method of claim 1, wherein:
providing a live chat thread related to the checked in to content to each consumer currently checked in to the content.

3. The computer-implemented method of claim 1, wherein:
the content choices available for check in comprise content choices that are associated with a live chatter feed.

4. The computer implemented method of claim 2, wherein:
provided listings information is presented to a consumer along with an indication associated with one or more content choices that at least one of the consumer's friends is checked in to the indicated content choices.

5. The computer-implemented method of claim 1, further comprising:
aggregating the checked in status of a plurality of consumers; and
analyzing based on the aggregated data to determine a consumer consumption statistic.

6. The computer-implemented method of claim 5, wherein:
the analysis describes the total number of consumers checked in to each content choice in the listing of content choices currently playing.

7. The computer-implemented method of claim 1, wherein:
the content choice is an on demand content.

8. The computer-implemented method of claim 1, wherein:
the received check in message is generated responsive to the consumer's selection of a content choice selected from a displayed listing of content choices.

9. The computer-implemented method of claim 1, further comprising:
analyzing the chat thread associated with the content choice for conversation trends.

10. A system comprising:
a consumer device configured to receive data and render the data in a graphical user interface; and
a listings check in service configured to transmit listings data to the consumer device,
the consumer device further configured to receive the listings data and to present, in the graphical user interface, a listing of content choices currently playing, configured to receive a check in message being indicative of a consumer's intention to check in to one of the content choices presented in the listing of content choices, and configured to transmit the check in message to the listing check in service;
the listings check in service further configured to receive the check in message from the consumer device, and configured to record the consumer's status as checked in to the content choice.

11. The system of claim 10, wherein the record of the consumer's checked in status is stored in association with a consumer profile.

12. The system of claim 10, further comprising:
aggregating the checked in status of the plurality of consumers; and
outputting an analytic based on the aggregated data.

13. The system of claim 12, wherein the analytic describes the total number of consumers checked in to each content choice in the listing of content choices playing.

14. The system of claim 10, wherein the listings check in service is further configured to provide a common chat thread to each consumer checked in to the content choice.

15. The system of claim 14, wherein the listings check in service is further configured to analyze the chat thread associated with the content choice for conversion trends.

16. A non-transitory computer-readable storage medium storing instructions which, when executed by a computing device, cause the computing device to execute the instructions comprising:
providing by a listings check in service data descriptive of listing of content choices currently available for check in for display in a graphical user interface;
receiving a check in message being indicative of a consumer's intention to check in to one of the content choices presented in the listing of content choices; and
recording an indication of the consumer's status as checked in to the content choice.

17. The non-transitory computer-readable storage medium of claim 16, further comprising:
publishing the consumer's status as checked in to the content choice to a community of consumers.

18. The non-transitory computer-readable storage medium of claim 16, wherein the content choice available for check in further includes a content choice in a consumer's personal library that the consumer has scheduled for a viewing.

19. The non-transitory computer-readable storage medium of claim 18, further comprising:
aggregating the checked in status of a plurality of consumers; and
outputting an analytic based on the aggregated data.

20. The non-transitory computer-readable storage medium of claim 18, further comprising:
providing a common chat thread to each consumer checked in to the content choice.

21. The non-transitory computer-readable storage medium of claim 20, further comprising:
analyzing the chat thread associated with the content choice for conversion trends.
